(19) United States
(12) Patent Application Publication
(10) Pub. No.: US 2006/0247803 A1
(43) Pub. Date: Nov. 2, 2006

(54) Control system, control method, process system, and computer readable storage medium and computer program

(76) Inventor: Kazushi Mori, Saga (JP)

Correspondence Address: Smith Gambrell & Russell, 1850 M Street, NW - Suite 800, Washington, DC, 20036, US

(21) Appl. No.: 10/541,378

(22) PCT Filed: Mar. 29, 2005
(86) PCT No.: PCT/JP05/05805

§ 371 Date: Jul. 6, 2005

(51) Int. Cl. G05B 9/02

(52) U.S. Cl. 700/80

(57) ABSTRACT

A control system comprises a control apparatus 17 that controls a process apparatus 10, which performs a predetermined process on a wafer W, based on plural pieces of process information to be detected in the process apparatus 10, and alarm generation means 21 which generates an alarm when the detected process information is off a predetermined range. The control apparatus 17 grasps the generation state of an alarm, and gives warning when the generation state reaches a predetermined threshold.

### FIELD OF THE INVENTION

The present invention relates to a control system, a control method, and a process system, which include a process apparatus that performs a predetermined process on an object to be processed at the time of fabricating, for example, a semiconductor device, a computer readable storage medium, and a computer program.

### DESCRIPTION OF THE RELATED ART

In a fabrication process for semiconductor devices, for example, various processes are performed on a semiconductor wafer (hereinafter simply written as wafer), for which various kinds of process apparatuses are used. There is, for example, a cleaning apparatus which performs soaking and processing a wafer in a single process bath or plural process baths retaining a process liquid thereafter drying, as such a process apparatus.

Such a cleaning apparatus is provided with a control system that receives various kinds of detection data from a temperature sensor which detects the temperature of a process liquid to be supplied to a substrate, a concentration sensor which detects the concentration of the process liquid, a position sensor which detects the position of the process liquid in the bath, and the like to detect the status of the cleaning apparatus, and controls the cleaning apparatus based on various kinds of detection data. When the detected value of a sensor exceeds a preset allowance value while the apparatus is in operation, the control system generates an alarm, considering that there is a possible occurrence of a failure in the apparatus.

In a wafer process, a plurality of process apparatuses are laid out to construct a process system, but the size of such a process system recently is becoming larger, so that there are ever increasing demands for integrated control of multiple process apparatuses.

Accordingly, individual process apparatuses are provided with control units that are connected to a host computer, which performs tracking of individual process apparatuses, stores process data, received from the process apparatuses, as a history, displays the contents thereof on a display device, and performs correction of various parameters, abnormality detection, and so forth of the process apparatuses, through exchange of various kinds of data with the control units of the process apparatuses.

Patent Literature 1 discloses that because process data to be stored is restrictive and it is difficult to find an abnormality in, and degrading of the characteristic of, a process apparatus early in an integrated control system using such a host computer, a controller, which collects all process data generated by the control units of individual process apparatuses, analyzes the collected process data and outputs the analysis results, is provided in addition to the host computer. This can increase process data to be grasped and can ensure early detection of a change in the status of each process apparatus with time.

However, process data from individual process apparatuses in such a system is vast. So is alarm information from the individual process apparatuses. It is not therefore easy to determine the status of the process apparatus from such information, and there have been demands of sufficiently managing an abnormality in apparatus and the service life of the apparatus. The use conditions of the apparatus differ from one user to another, so that even if an abnormality in apparatus, the abnormality and the service life of the apparatus are determined equally from process data, there may be a case where an abnormality in apparatus and reaching the service life of the apparatus have not actually occurred yet.

[Patent Literature 1]
Unexamined Japanese Patent Application KOKAI Publication No. H11-16797

### DISCLOSURE OF INVENTION

It is an object of the present invention to provide a control system and a control method, which can determine the status of a process apparatus based on alarm information and sufficiently manage an abnormality in apparatus, the service life of the apparatus, etc., a process system equipped with such a control system, and a computer readable storage medium and a computer program, which perform such control.

It is another object of the invention to provide a control system and a process method, which can predict or surely detect the actual abnormality in apparatus, and service life of the apparatus on the user level, and a computer readable storage medium and a computer program, which perform such control.

According to the first aspect of the invention, there is provided a control system comprising control means that controls a process apparatus, which performs a predetermined process on an object to be processed, based on information to be detected in the process apparatus; and alarm generation means which generates an alarm when the detected information is off a predetermined range, wherein the control means grasps a generation state of the alarm which is generated from the alarm generation means, and gives warning when the generation state reaches a predetermined threshold.

According to the second aspect of the invention, there is provided a control system comprising control means that controls a plurality of process apparatuses, which perform predetermined processes on an object to be processed, based on information to be detected in the process apparatuses; and alarm generation means which generates an alarm when the information to be detected is off a predetermined range, the control means including a plurality of apparatus control units that respectively control the plurality of process apparatuses based on plural pieces of information to be detected in the individual process apparatuses, a host computer that receives partial information from the individual process apparatuses and controls the individual process apparatuses based on that information, and a control apparatus that receives all or nearly all information from the individual process apparatuses and controls the individual process apparatuses based on that information, the control apparatus including means that collects information received from the individual control units and alarm information received from the alarm generation means, means that analyzes the collected information, and means that grasps a generation state of the alarm generated based on the alarm information, and gives warning when the generation state reaches a predetermined threshold.

According to the third aspect of the invention, there is provided a control method that controls a process apparatus, which performs a predetermined process on an object to be processed, based on plural pieces of information to be detected in the process apparatus, the method comprising: grasping a generation state of an alarm, which is generated when the detected information is off a predetermined range, and giving warning when the generation state reaches a predetermined threshold.

According to the fourth aspect of the invention, there is provided a process system comprising a process apparatus which performs a predetermined process on an object to be processed, and a control system which controls the process apparatus, the control system including control means that controls a process apparatus, which performs a predetermined process on an object to be processed, based on information to be detected in the process apparatus; and alarm generation means which generates an alarm when the detected information is off a predetermined range, wherein the control means grasps a generation state of the alarm which is generated from the alarm generation means, and gives warning when the generation state reaches a predetermined threshold.

According to the fifth aspect of the invention, there is provided a process system comprising which performs a predetermined process on an object to be processed, and a control system which controls the process apparatus, the control system including control means that controls a plurality of process apparatuses, which perform predetermined processes on an object to be processed, based on information to be detected in the process apparatuses; and alarm generation means which generates an alarm when the information to be detected is off a predetermined range, the control means including a plurality of apparatus control units that respectively control the plurality of process apparatuses based on plural pieces of information to be detected in the individual process apparatuses, a host computer that receives partial information from the individual process apparatuses and controls the individual process apparatuses based on that information, and a control apparatus that receives all or nearly all information from the individual process apparatuses and controls the individual process apparatuses based on that information, the control apparatus including means that collects information received from the individual control units and alarm information received from the alarm generation means, means that analyzes the collected information, and means that grasps a generation state of the alarm generated based on the alarm information, and gives warning when the generation state reaches a predetermined threshold.

According to the sixth aspect of the invention, there is provided a computer readable storage medium containing software that allows a computer to control a process apparatus, which performs a predetermined process on an object to be processed, based on plural pieces of information to be detected in the process apparatus, wherein the software grasps a generation state of an alarm, which is generated when the detected information is off a predetermined range, and gives warning when the generation state reaches a predetermined threshold.

According to the seventh aspect of the invention, there is provided a computer program containing software that allows a computer to control a process apparatus, which performs a predetermined process on an object to be processed, based on plural pieces of information to be detected in the process apparatus, wherein the software grasps a generation state of an alarm, which is generated when the detected information is off a predetermined range, and gives warning when the generation state reaches a predetermined threshold.

According to the invention, as the generation state of an alarm which is generated from the alarm generation means is grasped, and warning is given when the generation state reaches a predetermined threshold, an abnormality in apparatus and the service life of the apparatus can be detected or predicted early. Because it is possible to set the threshold of the generation state of an alarm which is generated from the alarm generation means, and analyze the generation state of the alarm according to the abnormality setting set arbitrarily to detect an abnormality in apparatus, warning can be given when an apparatus status, such as a process abnormality which a user actually wants to grasp, is reached. This makes it possible to surely detect or predict an abnormality in apparatus and the service life of the apparatus earlier. Specifically, as a user sets the threshold at which warning of the generation state of an apparatus alarm, such as the number of alarm generations within a predetermined time and a time from an alarm generation to the next alarm generation, and it is determined that an abnormality in apparatus has occurred when the threshold is reached, the status of the process apparatus can be determined surely on the user level, an abnormality in apparatus and the service life of the apparatus can be detected or predicted earlier and surely.

### BRIEF DESCRIPTION OF DRAWINGS

FIG. 1 Block diagram showing the general structure of a process system according to one embodiment of the invention.

FIG. 2 Diagram showing the structure of a portion associated with process data transfer in a main controller (MC) in a process apparatus to be used in the process system according to one embodiment of the invention.

FIG. 3 Perspective view showing one example of the process apparatus to be used in the process system according to one embodiment of the invention.

FIG. 4 Plan view showing one example of the process apparatus to be used in the process system according to one embodiment of the invention.

FIG. 5 Schematic diagram showing a first chemical bath and its piping system in the process apparatus to be used in the process system according to one embodiment of the invention.

FIG. 6 Block diagram showing main detection means connected to a block controller (BC).

FIG. 7 Diagram showing one example of an alarm generation state to be detected by an FDC function section of an AGC.

FIG. 8 Diagram showing another example of the alarm generation state to be detected by the FDC function section of the AGC.

FIG. 9 Diagram showing one example of a graph display of circumstances of alarm generation when a detection condition is designated in the FDC function section of the AGC.

FIG. 10 Diagram showing another example of the graph display of alarm generation circumstances when a detection condition is designated in the FDC function section of the AGC.

### BEST MODE FOR CARRYING OUT THE INVENTION

An embodiment of the invention will be described below referring to the accompanying drawings.

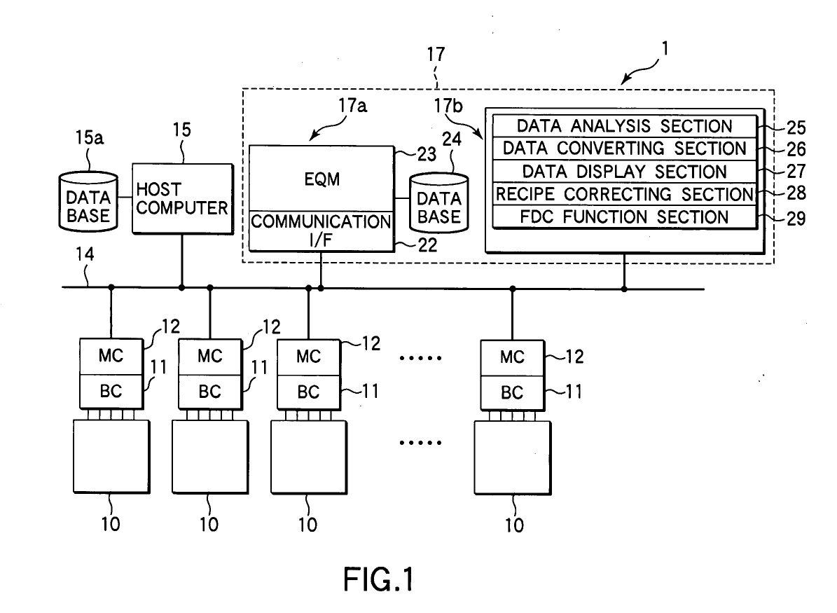

The following discusses a process system equipped with a process apparatus which cleans a wafer as a substrate by performing a liquid process thereon. FIG. 1 is a block diagram showing the general structure of the process system according to the embodiment.

This process system 1 has a plurality of process apparatuses 10 which clean a wafer by performing a liquid process thereon, and the individual process apparatuses 10 are controlled by a block controller (BC) 11 as a low-rank control system and a main controller (MC) 12 as a high-rank control system. The process system 1 has a host computer 15 which performs the general control of the system, and an advanced group controller (hereinafter written as AGC) which analyzes process data generated by the control systems of the individual process apparatuses and outputs the results.

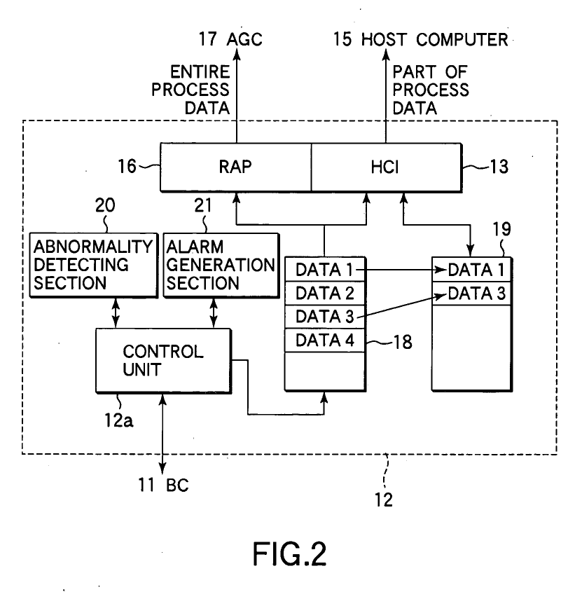

As shown in FIG. 2, the main controller (MC) 12 has a control unit 12a, which receives a detection signal through the block controller (BC) 11 and sends a control signal to the individual components of the process apparatus 10 based on the detection signal, an abnormality detecting section 20, which analyzes process information received from the control unit 12a and detects an abnormality, an alarm generation section 21 which generates an alarm based on abnormality detection information from the abnormality detecting section 20, a memory 18 where entire process information and alarm information, which are received from the process apparatus 10 via the block controller (BC) 11 and subjected to signal processing in the control unit 12a, are temporarily stored, an HCI transmission buffer 19, which acquires some preset types of process data (data 1, 3) from the memory 18 and writes the information, an HCI (Host Communication Interface) 13 as logical interface means to the host computer 15, and an RAP (Remote Agent Process) 16 as logical interface means to an AGC 17. Exchange of various kinds of data with the host computer 15 through a data transmission system 14, such as TCP/IP, is executed by the HCI 13. Exchange of various kinds of data with the AGC 17 is executed by the RAP 16 through the data transmission system 14.

The HCI 13 selects some preset types of process data from all the process data acquired from the process apparatus 10 by the main controller 12, and sends the data to the host computer 15. That is, the HCI 13 acquires some preset types of process data (data 1, 3) from the memory 18 where entire process data generated by the main controller (MC) 12 are temporarily stored, writes the data in the HCI transmission buffer 19, and sends the contents of the HCI transmission buffer 19 to the host computer 15 at a time. Status data or the like generated by the main controller (MC) 12 is also sent.

The RAP 16 sends all the process data acquired from the process apparatus 10 by the main controller (MC) 12 to the AGC 17 unconditionally. That is, the RAP 16 sequentially reads process data, stored in the process data storage memory 18 in the main controller (MC) 12, from the top, and transfers it with the data structure unchanged to the AGC 17. It is to be noted however that an operation to an extent, such as changing the sequential order of data or removal of just a part of data may be carried out here.

The host computer 15 performs the general operational control of the individual process apparatuses 10, such as tracking of each process apparatus 10 through exchange of various kinds of data with the main controller (MC) 12 of each process apparatus 10.

The AGC 17 executes processes including intensive management of recipes (process condition values) for each process apparatus and process control of each process apparatus 10 based on the recipes, analysis and statistical processing of all process data acquired from each process apparatus 10, intensive monitoring of process data and its analysis/statistical results, a process of reflecting the analysis/statistical results on recipes, and the like.

The AGC 17 comprises an AGC server 17a and an AGC client 17b.

The AGC server 17a has a communication I/F (Interface section) 22, an EQM control unit 23 and a database 24. The communication I/F (Interface section) 22 transmits and receives various kinds of data between the main controller (MC) 12 of each process apparatus 10 and the AGC client 17b via the data transmission system 14. The EQM control unit 23 mainly performs correction of various parameters of processes for each process apparatus based on predefined process conditions and process data acquired from each process apparatus 10, and processes, such as storage of received parameters into the database 24 and retrieval of process data to be transferred to the AGC client 17b from the database 24.

The AGC client 17b has a data analysis section 25, which performs analysis and statistical processing of process data transferred from the AGC server 17a, a data converting section 26 which converts acquired process data and its analysis results or the like to data of the format that a client user can use and process, a data display section 27 which displays converted data on a monitor or the like, a recipe correcting section 28 which updates recipes (process conditions) for optimization based on the results of analysis of process data including measured data of the film thickness and the like on an object to be processed, and an FDC (Fault Detection and Classification) function section 29 having functions of defining an abnormality in apparatus on the user level besides generation of an apparatus alarm, analyzing the generation state of the alarm according to the abnormality setting arbitrarily made, and detecting an abnormality in apparatus in real time. Recipes may be stored on a hard disk or a semiconductor memory, or may be set retained in a portable storage medium, such as a CD-ROM or DVD, at predetermined positions. Further, recipes may be transferred adequately from another apparatus, for example, via an exclusive circuit.

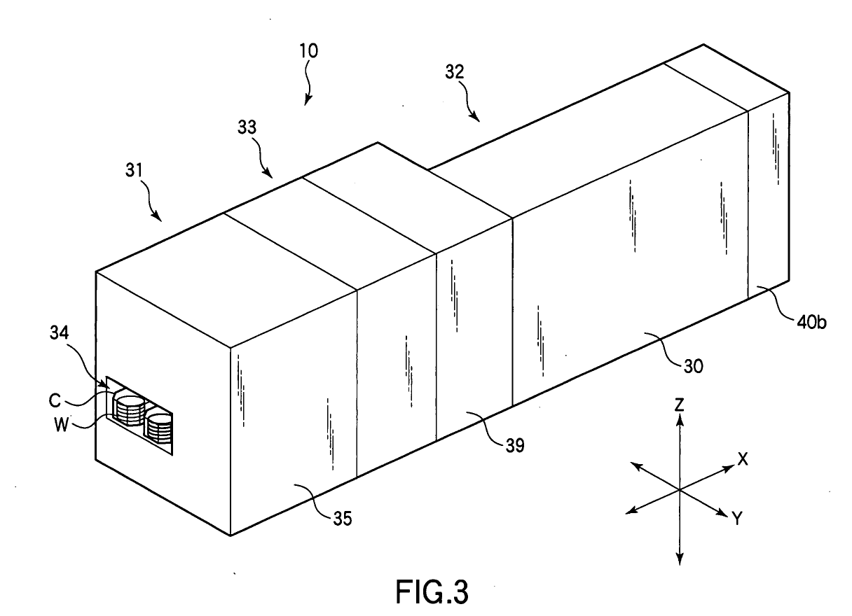

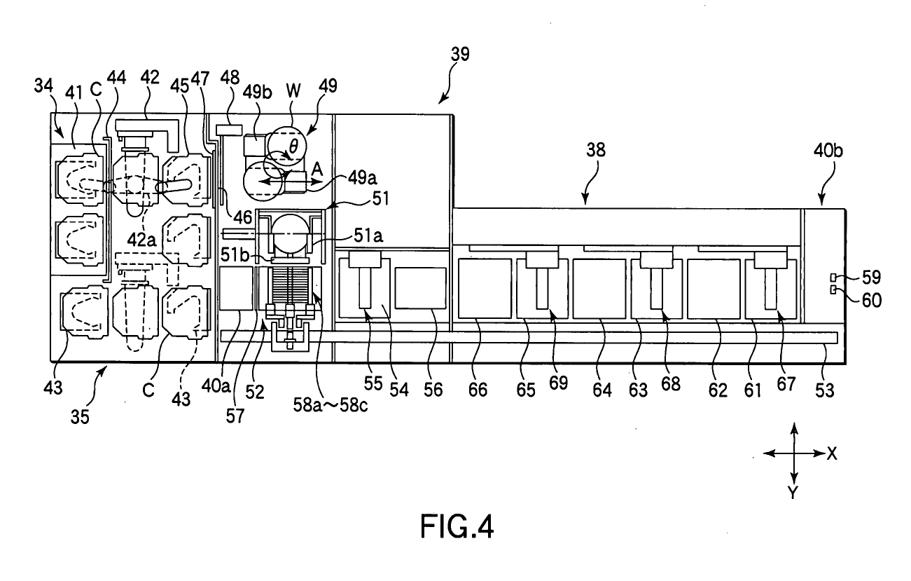

Next, one example of the process apparatus 10 will be discussed. FIG. 3 is a perspective view of the process apparatus 10, and FIG. 4 is a plan view thereof.

The process apparatus 10 mainly comprises a load/unload section 31 which performs loading and unloading and storage or so of a carrier C where a wafer W is retained horizontally, a processing section 32 which performs a cleaning process on the wafer W using a predetermined chemical solution and a drying process or the like, and an interface section 33 which conveys the wafer W between the load/unload section 31 and the processing section 32.

The load/unload section 31 comprises a carrier load/unload section 34 where a stage 41 for mounting a carrier C capable of retaining a predetermined number of, for example, twenty-five, wafers W is formed, and a carrier stock section 35 capable of storing a plurality of carriers C. The carrier C retains wafers W horizontally at predetermined intervals, with its one side being a load/unload port for the wafers W, which has such a structure as to be openable and closable with a lid. The carrier stock section 35 is provided with a plurality of carrier holding members 43 which hold the carriers C. A carrier C which retains unprocessed wafers W and is mounted on the stage 41 is carried into the carrier stock section 35 by a carrier conveying device 42, while a carrier C which retains processed wafers W is carried to the stage 41 from the carrier stock section 35 using the carrier conveying device 42.

A shutter 44 is provided between the carrier load/unload section 34 and the carrier stock section 35. The shutter 44 is opened at the time of transferring the carrier C between the carrier load/unload section 34 and the carrier stock section 35, and is closed otherwise to isolate the atmosphere between the carrier load/unload section 34 and the carrier stock section 35.

The carrier conveying device 42 has an arm 42a, such as a multi-joint arm or a telescopic arm, which is driven in such a way as to be able to move at least a carrier C, for example, in the X direction, and the carrier C is conveyed held with such an arm 42a. The carrier conveying device 42 can be driven in the Y direction and Z direction (height direction) by an unillustrated Y-axis drive mechanism and Z-axis drive mechanism, so that the carrier C can be mounted on the carrier holding member 43 laid out at a predetermined position.

In FIG. 4, the carrier holding members 43 are provided near the wall surface where the carrier stock section 35 is formed, in plural stages, for example, four stages, at each location in the height direction. The carrier stock section 35 serves to temporarily store carriers C retaining unprocessed wafers W, or store empty carriers C from which the wafers W have been removed.

A window 46 is formed at the boundary between the carrier stock section 35 and the interface section 33, and an inspection/load/unload stage 45 having a structure similar to that of the carrier holding member 43 is provided on the carrier stock section 35 side of the window 46 so that the carrier C can be mounted in such a way that the lid of the carrier C faces the window 46. The carrier conveying device 42 may hold the carrier C for a given time at predetermined space facing the window 46 without providing the inspection/load/unload stage 45. A lid open/close mechanism 47 for opening and closing the lid of the carrier C mounted on the inspection/load/unload stage 45 is provided on the carrier stock section 35 side of the window 46, so that with the window 46 and the lid of the carrier C being open, the wafers W in the carrier C can be carried out toward the interface section 33, or wafers W can be carried into an empty carrier C from the interface section 33 side. The lid open/close mechanism 47 may be provided on the interface section 33 side of the window 46.

A wafer inspecting device 48 for measuring the quantity of wafers W in the carrier C is provided on the interface section 33 side of the window 46. The wafer inspecting device 48 checks the quantity of the wafers W by causing, for example, an infrared sensor head having a transmission section and a reception section to scan in the Z direction in the vicinity of the X-directional ends of the wafers W retained in the carrier C and detecting a signal of transmitted light or reflected light of the infrared light between the transmission section and the reception section. It is preferable to use the wafer inspecting device 48 that has a function of detecting the retained state of wafers W, such as whether or not the wafers W are laid out one on another in parallel at predetermined pitches in the carrier C or whether or not the wafers W are retained misaligned and obliquely, in parallel to checking of the quantity of wafers W. The quantity of the wafers W may be detected using the sensor after the retained state of the wafers W is checked. The wafer inspecting device 48 is wire-connected as a signal input device to the block controller (BC) 11, and sends the detected quantity retained and the retained state as output signals to the block controller (BC) 11.

The operations of the carrier conveying device 42 and the wafer inspecting device 48 are controlled by the host computer 15 via the block controller (BC) 11 and the main controller (MC) 12. For example, the carrier conveying device 42 is controlled in such a way that after the quantity of wafers W in a carrier C is checked by the wafer inspecting device 48, the carrier C is stored in the carrier stock section 35. The opening/closing of the shutter 44, the opening/closing of the window 46 and the operation of the lid open/close mechanism 47 are controlled interlocked with the movement of the carrier conveying device 42.

The interface section 33 is provided with a wafer load/unload device 49, a wafer transfer device 51 and a wafer conveying device 52. The wafer transfer device 51 comprises an attitude conversion mechanism 51a which exchanges a wafer W with the wafer load/unload device 49 and converts the attitude of the wafer W, and a wafer vertical holding mechanism 51b which exchanges a wafer W between the attitude conversion mechanism 51a and the wafer conveying device 52.

The wafer load/unload device 49 unloads wafers W in the carrier C through the window 46 and transfers it to the attitude conversion mechanism 51a, and receives wafers W having undergone the liquid process from the attitude conversion mechanism 51a and carries into the carrier C. The wafer load/unload device 49 has two kinds of arms, arms 49a which carry unprocessed wafers W and arms 49b which carry a processed wafers W. A predetermined number of the arms 49a and 49b are laid out at predetermined intervals in the Z direction according to the layout pitch of wafers W in the carrier C, so that the arms 49a and 49b can hold plural wafers W retained in the carrier C at a time. In the state shown in FIG. 4, the arms 49a and 49b are movable (slidable) or expandable in the direction of an arrow A, and are elevatable by a predetermined distance in the Z direction. Further, the entire wafer load/unload device 49 is so constructed as to be rotatable in a θ direction, so that the arms 49a and 49b can access to any of the carrier C mounted on the inspection/load/unload stage 45, and the attitude conversion mechanism 51a.

In the wafer load/unload device 49, for example, with the arms 49a being on the wafer transfer device 51 side, the arms 49a are inserted under the wafers W and is lifted upward by a predetermined distance to hold the wafers W, after which the arms 49a are moved in the opposite direction to carry out the wafer W of the carrier C. Next, the whole wafer load/unload device 49 is rotated by 90 degrees, and then the arms 49a are moved to transfer the wafers W held on the arms 49a to the attitude conversion mechanism 51a. With the arms 49b being on the processing section 32 side, on the other hand, the arms 49b are moved to take out wafers W having undergone the liquid process from the attitude conversion mechanism 51a, after which the whole wafer load/unload device 49 is rotated by 90 degrees, and then the arms 49b are set on the wafer transfer device 51 side and are moved to carry the wafers W held on the arms 49b moved to transfer the wafer W held on the arm 49b into an empty carrier C.

In the attitude conversion mechanism 51a of the wafer transfer device 51, a plurality of horizontal wafers W are received from the wafer load/unload device 49 through a guide member, and the guide member is rotated in that state to change the state of the wafers W to the vertical state.

The wafer vertical holding mechanism 51b can retain two carriers of, or 50, wafers W whose state has been changed to the vertical state by the attitude conversion mechanism 51a at a layout pitch which is half the layout pitch of wafers in the carrier C, and transfers the two carriers of wafers W to the wafer conveying device 52.

The wafer conveying device 52 delivers vertical wafers W to or from the wafer vertical holding mechanism 51b and carries unprocessed wafers W into the processing section 32, or carries out wafers W having undergone the liquid process or so from the processing section 32 and transfers the wafers W to the wafer vertical holding mechanism 51b. In the wafer conveying device 52, wafers W are held by three chucks 58a to 58c. The wafer conveying device 52 moves in the X direction along a guide rail 53 to be able to move into/out from the processing section 32 in such a way that the wafer conveying device 52 can deliver wafers W to or from the wafer vertical holding mechanism 51b and carry wafers W into the processing section 32.

To check whether or not wafers W having undergone the liquid process are damaged or misaligned or so, a wafer detection sensor 57 to check the layout state of wafers W is provided at a position where the wafers W are delivered between the wafer vertical holding mechanism 51b and the wafer conveying device 52. The wafer detection sensor 57 is not limited to such a position but can be any position where a check is done while processed wafers W are carried to the wafer load/unload device 49. The wafer detection sensor 57 is wire-connected as a signal input device to the block controller (BC) 11 and sends the detected value as an output signal to the block controller (BC) 11.

The interface section 33 is provided with a parking area 40a on the side of the position where wafers W are exchanged between the wafer vertical holding mechanism 51b and the wafer conveying device 52, so that unprocessed wafers W, for example, can stand by in the parking area 40a. For instance, at the time the liquid process or the dry process is performed on wafers W of one lot, wafers W for which the liquid process are to be initiated next should have been carried to the parking area 40a using the time during which the wafer conveying device 52 need not be operated. This can shorten the time for moving wafers W to the processing section 32 as compared with, for example, a case where wafers W are carried from the carrier stock section 35, so that the throughput can be improved.

The processing section 32 comprises a liquid process unit 38, a drying unit 39, and a parking area 40b, which are arranged in the order of the drying unit 39, the liquid process unit 38 and the parking area 40b from the interface section 33 side. The wafer conveying device 52 can move inside the processing section 32 along the guide rail 53 extending in the X direction.

The parking area 40b, like the parking area 40a, is where unprocessed wafers W are to sand by. Using the time during which the wafer conveying device 52 need not be operated for the liquid process or the dry process is performed on wafers W of one lot, wafers W for which the liquid process are to be initiated next are carried to the parking area 40b. As the parking area 40b is adjacent to the liquid process unit 38, the time for moving wafers W can be shortened at the time of initiating the liquid process, so that the throughput can be improved.

The liquid process unit 38 has a first chemical bath 61, a second chemical bath 63, a third chemical bath 65, a first rinse bath 62, a second rinse bath 64, and a third rinse bath 66, which are arranged in the order of the first chemical bath 61, the first rinse bath 62, the second chemical bath 63, the second rinse bath 64, the third chemical bath 65, and the third rinse bath 66 from the parking area 40b side, as shown in FIG.4. A conveying device 67 for transferring wafers W between the first chemical bath 61 and the first rinse bath 62, a conveying device 68 for transferring wafers W between the second chemical bath 63 and the second rinse bath 64, and a conveying device 69 for transferring wafers W between the third chemical bath 65 and the third rinse bath 66 are provided.

A chemical solution for removing an organic stain or a surface metal impurity is retained in the first chemical bath 61. As a chemical solution for removing an organic stain or a surface metal impurity, an SPM solution (a mixed solution of concentrated sulfuric acid and a hydrogen peroxide solution) heated to, for example, around 130° C. is retained. A chemical solution for removing a deposit, such as particles, e.g., an SC-1 solution (a mixed solution of ammonia, hydrogen peroxide and water) is retained in the second chemical bath 63, and an etchant for etching an oxide film formed on the top surface of a wafer W, e.g., a diluted hydrofluoric acid (DHF), is retained in the third chemical bath 65. As an etchant, in addition to the diluted hydrofluoric acid, a mixture of a hydrofluoric acid (HF) and ammonium fluoride (buffered hydrofluoric acid (BHF)) can be used. In case of etching a nitride film formed on the top surface of a wafer W, phosphate can be used as an etchant. The first to third rinse baths 62, 64 and 66 are for respectively removing chemical solutions adhered to a wafer W through the liquid processes in the first to third chemical baths 61, 63 and 65, and various kinds of rinsing schemes, such as overflow rinse and quick dump rinse, are used.

the conveying device 67 has a drive mechanism elevatable in the Z direction, and operates in such a way as to lower wafers W received from the wafer conveying device 52 to be bathed in the first chemical bath 61, pull them up after a predetermined time, then move the wafers W in parallel in the X direction, bathe and hold the wafers W in the first rinse bath 62 for a predetermined time, then pull them up. The wafers W that have undergone the process in the first rinse bath 62 are returned to the chucks 58a to 58c of the wafer conveying device 52, and then are carried to the conveying device 68 from the wafer conveying device 52. The conveying devices 68 and 69 have structures similar to the structure of the conveying device 67, and operate similarly.

A liquid-process-unit thermometer 59 which detects the temperature of the atmosphere in the liquid process unit 38, and a liquid-process-unit manometer 60 which detects pressure are provided in the liquid process unit 38. The liquid-process-unit thermometer 59 and the liquid-process-unit manometer 60 are wire-connected as signal input devices to the block controller (BC) 11, and respectively send the detected temperature and pressure to the block controller (BC) 11.

The drying unit 39 is provided with a rinse bath 54 and a chuck cleaning mechanism 56 which cleans the chucks 58a to 58c of the wafer conveying device 52, and a dry chamber (not shown) to which vapor of, for example, isopropyl alcohol (IPA) is supplied to dry wafers W is provided at the upper portion of the rinse bath 54. A conveying device 55 which conveys between the rinse bath 54 and the dry chamber is provided so that wafers W rinsed in the rinse bath 54 are pulled up and subjected to IPA drying in the dry chamber. The conveying device 55 is constructed in a similar way as the above-described conveying device 67 or the like, except that it cannot move in the X direction, so that exchange of the wafers W with the wafer conveying device 52 is possible.

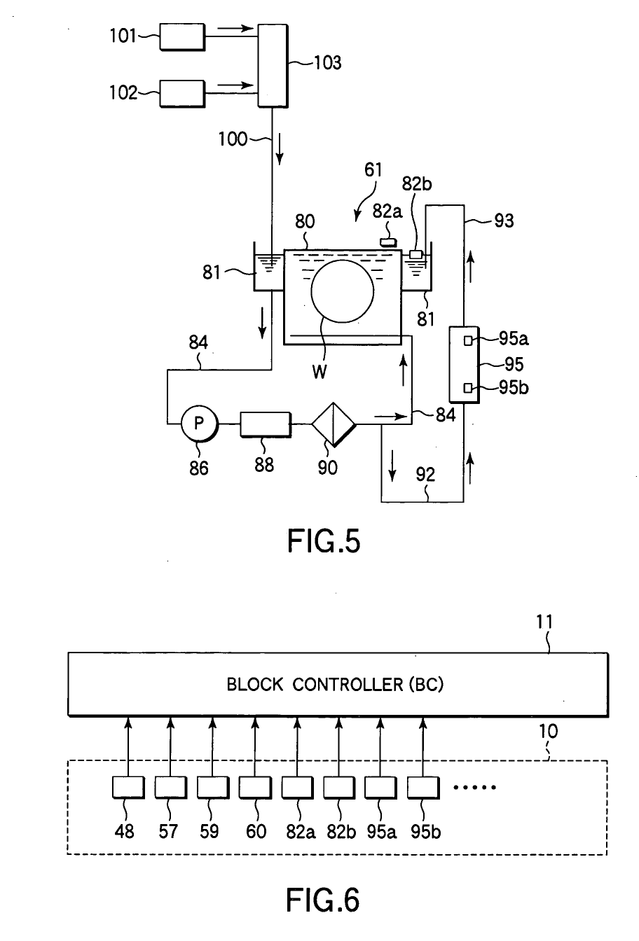

The first chemical bath 61, as shown in FIG. 5, comprises a box-shaped inner bath 80 with sizes large enough to retain wafers W and outer bath 81. The top side of the inner bath 80 is open, so that wafers W are carried in and out of the inner bath 80 through the opening at the top side. The outer bath 81 is attached surrounding the opening of the inner bath 80 in such a way as to receive a chemical solution overflowing from the top end of the inner bath 80. Further, liquid level sensors 82a and 82b for measuring the positions of the liquid levels are provided at the liquid levels of the chemical solutions to be retained in the inner bath 80 and the outer bath 81. Those liquid level sensors 82a and 82b are wire-connected as signal input devices to the block controller (BC) 11, and send the detected positions of the liquid levels to the block controller (BC) 11 as output signals.

A circulation supply circuit 84 which supplies a chemical solution in circulation during the etching of wafers W is connected between the inner bath 80 and the outer bath 81. One of the circulation supply circuit 84 is connected to the bottom of the outer bath 81, a pump 86, a temperature control unit 88 and a filter 90 are laid out in order in a midway of the circulation supply circuit 84, and the other of the circulation supply circuit 84 is connected to a nozzle in the inner bath 80. Therefore, the chemical solution which has overflowed from the inner bath 80 to the outer bath 81 flows into the circulation supply circuit 84, passes the temperature control unit 88 and the filter 90, in order, for temperature regulation and filtering by the activation of the pump 86, and then is supplied into the inner bath 80 again through the nozzle. The nozzle is laid out under the outer bath 81 and is so constructed as to supply a chemical solution toward the top surface of the wafer W.

The temperature control unit 88 has a function of pre-cooling or pre-heating a chemical solution to be supplied into the inner bath 80 from the circulation supply circuit 84 before bathing so that the temperature of the chemical solution in the inner bath 80 does not become lower than or higher than a predetermined process temperature. The supply of a pre-cooled or pre-heated chemical solution into the inner bath 80 this way can keep the temperature of the chemical solution in the inner bath 80. The temperature control unit 88 is wire-connected as a signal output device to the block controller (BC) 11, and receives a control signal output from the block controller (BC) 11. For instance, the temperature control unit 88 comprises a heater, a heat exchanger and coolant supply means, and a valve disposed in the coolant supply passage for supplying a coolant into the heat exchanger and the heater are connected to the block controller (BC) 11. A predetermined control signal is sent to either the heater or the valve via the block controller (BC) 11 as needed.

A branch pipe 92 for flow of the chemical solution in the circulation supply circuit 84 to the outer bath 81 is connected to a midway of the circulation supply circuit 84, and the branch pipe 92 is provided with a concentration/temperature detecting section 95 for detecting the concentration and the temperature of a chemical solution. The concentration/temperature detecting section 95 is wire-connected to the block controller (BC) 11 as a signal input device. The concentration/temperature detecting section 95 is provided with a thermometer 95a which detects the temperature of the chemical solution, and a densitometer 95b which detects the concentration of the chemical solution, and they send the detected temperature and concentration as output signals to the block controller (BC) 11.

The branch pipe 92 is thinner than the pipe of the circulation supply circuit 84; for example, the diameter of the branch pipe 92 is ⅓ of the diameter of the circulation supply circuit 84. In this case, as generation of turbulence can be prevented, ultrasonic waves to be used in measuring the concentration are not influenced by the eddy flow even when an ultrasonic densitometer is used in the concentration/temperature detecting section 95. The influence of a change in pressure of the chemical solution, caused by driving of the pump 86, on measurement of the concentration is suppressed. Therefore, highly accurate concentration measuring is possible.

The first chemical bath 61 is provided with a chemical-solution supply circuit 100 for filling the bath with a chemical solution. The chemical-solution supply circuit 100 has a chemical-solution source 101, a pure-water source 102 and a mixture supply section 103 which mixes a chemical solution and pure water. The mixture supply section 103 is wire-connected to the block controller (BC) 11 as a signal output device. The chemical-solution supply circuit 100 serves as chemical solution supplementing means, and is controlled in such a way as to supplement the chemical solution from the chemical-solution source 101, the pure-water source 102 when the concentration of the chemical solution in the first chemical bath 61 drops.

The other end of the chemical-solution supply circuit 100 is connected to the outer bath 81, so that the adjusted chemical solution temporarily flows to the circulation supply circuit 84, and is supplied to wafers W from below the inner bath 80 after its temperature is adjusted.

As the first and second chemical baths 63 and 65 have structures and functions nearly the same as those of the first chemical bath 61 and the piping system discussed above, the descriptions will be omitted. The first to third rinse baths 62, 64 and 66 basically have similar structures and functions. That is, they have a rinse bath comprising an inner bath and an outer bath, and a circulation supply circuit from which pure water is supplied to the rinse bath.

As described above, the process apparatus 10 has various detection means which detect the statuses of the individual components. That is, as mentioned above, the liquid-process-unit thermometer 59 and the liquid-process-unit manometer 60 are provided as detection means to detect the status of the atmosphere in the liquid process unit 38. The liquid level sensors 82a and 82b, and the thermometer 95a and the densitometer 95b of the concentration/temperature detecting section 95 are provided as detection means to detect the statuses of the first chemical bath 61 and the individual sections of its piping system. Similar liquid level sensors, and the thermometer and the densitometer of the concentration/temperature detecting section are provided in the second and third chemical baths 63 and 65 and the piping systems. Further, the wafer inspecting device 48 is provided at the interface section 33 as detection means to detect the storage state of wafers W, and the wafer detection sensor 57 is provided as detection means to detect the layout state of wafers W. Other various detection means are provided. They perform predetermined detections as described above, and send the detected values as output signals to the block controller (BC) 11 as shown in FIG. 6.

The output signals of the wafer inspecting device 48, the wafer detection sensor 57, the liquid-process-unit thermometer 59, the liquid-process-unit manometer 60, the liquid level sensors 82a and 82b, the thermometer 95a and the densitometer 95b provided in the concentration/temperature detecting section 95, and other multiple detection means are sent to the block controller (BC) 11 at predetermined time intervals, are sent to the AGC 17 via the main controller (MC) 12, and are detected as detection signals representing the statuses of the individual sections of the process apparatus, so that changes in the statuses of the individual sections of the process apparatus can be detected. Further, when the abnormality detecting section 20 of the main controller (MC) 12 detects a detection signal exceeding an allowable value, the alarm generation section 21 generates an alarm to the operator.

Next, the control operation of the process system will be described.

In the process apparatus 10, a carrier C constituting one lot is placed on the inspection/load/unload stage 45 from the load/unload section 31 or the carrier stock section 35 using the carrier conveying device 42, the lid of the carrier C is opened by the lid open/close mechanism 47, further the window 46 is opened, and the quantity and the storage state of wafers W retained in the carrier C are checked by the wafer inspecting device 48. The carrier C whose abnormality has not been detected by the check is given to the attitude conversion mechanism 51a by the arm 49a, and is given to the wafer vertical holding mechanism 51b after its posture is converted by the attitude conversion mechanism 51a. For the other carrier C, the posture conversion of wafers W is carried out by the attitude conversion mechanism 51a and the wafers W are given to the wafer vertical holding mechanism 51b. Accordingly, 50 wafers W are aligned in the wafer vertical holding mechanism 51b.

The wafer vertical holding mechanism 51b is slid toward the wafer conveying device 52 and the wafers W are transferred to the chucks 58a to 58c. The wafer conveying device 52 holding the wafers W is moved to the position of the first chemical bath 61 or the first rinse bath 62 of the liquid process unit 38 along the guide rail 53, the wafers W are transferred to the conveying device 67, and the liquid process on the wafers W is initiated. The liquid process the wafers W is carried out in the order of, for example, soaking into the first chemical bath 61 and rinsing in the first rinse bath 62, basing into the second chemical bath 63 and rinsing in the second rinse bath 64, and soaking into the third chemical bath 65 and rinsing in the third rinse bath 66.

The wafers W whose processing in the liquid process unit 38 is finished are transferred to the wafer conveying device 52, and then transferred to the conveying device 55 of the drying unit 39 to undergo the dry process. The wafers W that has undergone the dry process are transferred to the wafer conveying device 52, and are returned to the interface section 33 for checking the status of the wafers W by the wafer detection sensor 57. If an abnormality in the status of the wafers W is detected, an action, such as stopping the liquid process apparatus 1 and doing maintenance, is taken. The wafers W which have undergone the liquid process and are returned to the interface section 33 can be retained in an empty carrier C mounted on the inspection/load/unload stage 45 in the opposite procedures to the procedures of carrying unprocessed wafers W from the carrier stock section 35 to the wafer conveying device 52. The carrier C where the wafers W which have undergone the liquid process are retained is carried to the carrier load/unload section 34 to be sent to the next step.

The processing operation on wafers W as objects to be processed is controlled and executed by the corresponding block controller (BC) 11 and main controller (MC) 12 under the process control of the host computer 15 and the AGC 17.

In each main controller (MC) 12, process data acquired from the process apparatus 10 through the block controller (BC) 11 is written in the memory 18 shown in FIG. 2. The process data written in the memory 18 is transferred to the host computer 15 and the AGC 17 through an independent channel of the data transmission system 14, such as TCP/IP, by the HCI 13 and the RAP 16 which are logical interface means associated with external transfer of the process data.

Here, the HCI 13 extracts only some preset types of process data from all the process data stored in the memory 18, writes the data in the HCI transmission buffer 19, and sends the contents of the HCI transmission buffer 19 to the host computer 15 via the data transmission system 14. Meanwhile, the RAP 16 reads all the process data from the memory 18 and transfers the data to the AGC 17.

The AGC server 17a of the AGC 17 receives the process data transmitted by the RAP 16 of the main controller (MC) 12 of each process apparatus 10, stores the process data in the database 24, generates a parameter correction value of each process apparatus from the process data and recipe data, and sends the value to the main controller (MC) 12 to perform process control.

When receiving a process data transfer request from the AGC client 17b, the AGC server 17a reads the corresponding process data from the database 24, and transmits the data to the AGC client 17b via the communication I/F 22. The process data transferred to the AGC client 17b is converted by the data converting section 26 to data of the format that a client user can use and process, and is displayed on the monitor by the data display section 27. Further, the process data transferred to the AGC client 17b is subjected to analysis and statistical processing in the data analysis section 25, and the analysis results, like the process data, are converted by the data converting section 26 to data of the format that a client user can use and process, and are displayed on the monitor. This achieves integrated control of the entire substrate process system on the AGC client 17b.

The data analysis section 25 of the AGC client 17b performs abnormality detection and abnormality prediction of the process apparatus from the results of analyzing the process data, and, when detecting or predicting an abnormality, sends an output to that effect to the monitor through the data display section 27 and informs the AGC server 17a of that effect. According to the notification, the AGC server 17a performs such control as instructing stopping of the main controller (MC) 12 which is controlling the process apparatus 10 whose abnormality is detected or predicted.

Further, the recipe correcting section 28 of the AGC client 17b performs an update process to optimize recipes (process conditions) from the results of analysis on the process data including measured data, such as the results of measuring the film thickness on the substrate.

Because the amount of process data to be analyzed in the data analysis section 25 is vast and the amount of alarm information from each process apparatus is also vast, actually, it is not easy to determine the status of the process apparatus from analysis information from the data analysis section 25, and it is often difficult to quickly and sufficiently control an abnormality in apparatus and the service life of the apparatus. The use conditions of the apparatus differ from one user to another, so that even if an abnormality in apparatus and the service life of the apparatus are determined equally from the analysis information from the data analysis section 25, there may be a case where an abnormality in apparatus and reaching the service life of the apparatus have not actually occurred yet. According to the embodiment, therefore, as mentioned above, the AGC client 17b is provided with the FDC function section 29 to provide functions of defining an abnormality on the user level in addition detection of an abnormality in apparatus (generation of an apparatus alarm) to detect, in real time, the abnormality setting arbitrarily made, so that an abnormality in apparatus and the service life of the apparatus can be sufficiently and surely detected or predicted.

The output signals of the wafer inspecting device 48, the wafer detection sensor 57, the liquid-process-unit thermometer 59, the liquid-process-unit manometer 60, the liquid level sensors 82a and 82b, the thermometer 95a and the densitometer 95b provided in the concentration/temperature detecting section 95, etc. are sent to the AGC 17 via the block controller (BC) 11 and the RAP 16 of the main controller (MC) 12 at predetermined time intervals, and stored in the database 24 of the AGC server 17a, and alarm information, which is generated by the alarm generation section 21 when the abnormality detecting section 20 detects detection signals exceeding the allowable values from those detection means, is also sent to the AGC 17, and those are stored in the database 24 of the AGC server 17a. For the generation states of those alarms, the FDC function section 29 allows a predetermined threshold to be set by the user level, monitors the generation state of a predetermined alarm, and gives warning when that generation state reaches the threshold.

As a specific example, an automatic monitoring function can be provided so that when an alarm in one detection means is generated, its entry is automatically made to activate the FDC function, so that the FDC function section 29 automatically starts monitoring. In this case, every time an alarm in various detection means is generated, entry of the FDC function is automatically done in order. Instead of such an automatic monitoring function, arbitrary detection means may be set so that when an alarm is generated in the set detection means, the FDC function is activated.

There are multiple detection means which generate alarms, in addition to those mentioned above, and in case of automatic monitoring, the upper limit of the number of entries should be set. It is therefore preferable to provide a function of automatically removing an entry considering that there is a low possibility of a problem having occurred in an apparatus when the threshold is not reached for a given time, and to allow a user to set the function on or off and set its time. It is also possible to provide a function of automatically removing an entry when the time from the initiation of monitoring an alarm to giving of warning or the time from giving of one warning to giving of next warning exceeds a predetermined time, and to allow a user to set the function on or off and set its time. Further, because of multiple types of alarms, it is preferable to classify all the alarms by, for example, the individual components of the process apparatus 10.

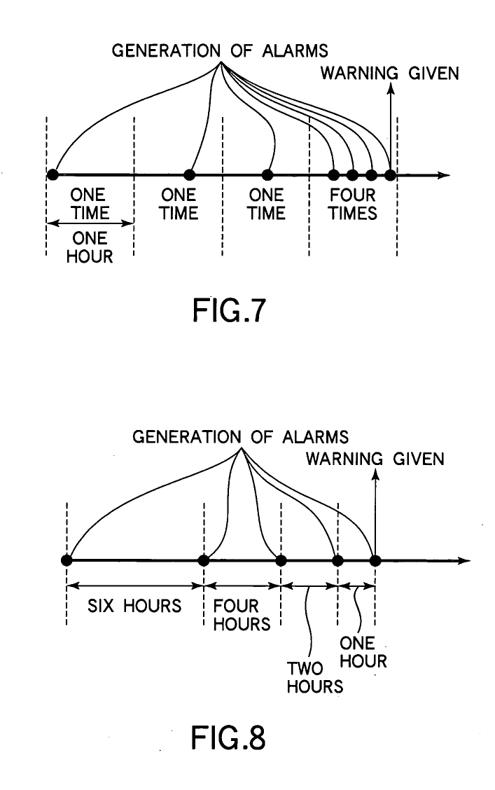

The typical examples of the generation state of an alarm to be grasped are the number of alarms generated within a predetermined time, and the time from one alarm generation to the next alarm generation, and those can be set as detection conditions. That is, in the former case, setting is done in such a way that warning is given when the number of alarms generated within a predetermined time reaches a predetermined number of times. As shown in FIG. 7, for example, warning is given when the number of alarms generated in one hour reaches four. In the latter case, setting is done in such a way that warning is given when the time from generation of an alarm to generation of the next alarm is within a predetermined time. As shown in FIG. 8, for example, warning is given when, after generation of an alarm, a next alarm is generated in one hour. And, a user can set the “predetermined time” and the “number of alarms generated” in the predetermined time in the former case, and a user can set the time from generation of an alarm to the next alarm generation in the latter case.

Information about the FDC function section 29 is also displayed on the monitor by the data display section 27. That is, designating an ID of the FDC function changes the display screen to the FDC function screen through which various settings and status display can be done for example, it is possible to display a list of alarms and individually designate alarms. In this case, it is preferable to display alarms classification by classification. It is possible to set the FDC function on or off from the display screen. It is also possible to set whether the FDC function should be enabled or no for each process apparatus. Further, it is possible to make the setting of the detection conditions through the display screen. Furthermore, warning which is given when the generation of a predetermined alarm reaches the threshold is displayed on the display screen. It is possible to do setting on how to report warning in that case. For example, a messenger service report, a mail report, no report, and so forth can be set. The accumulated number of times warning is generated can also be displayed.

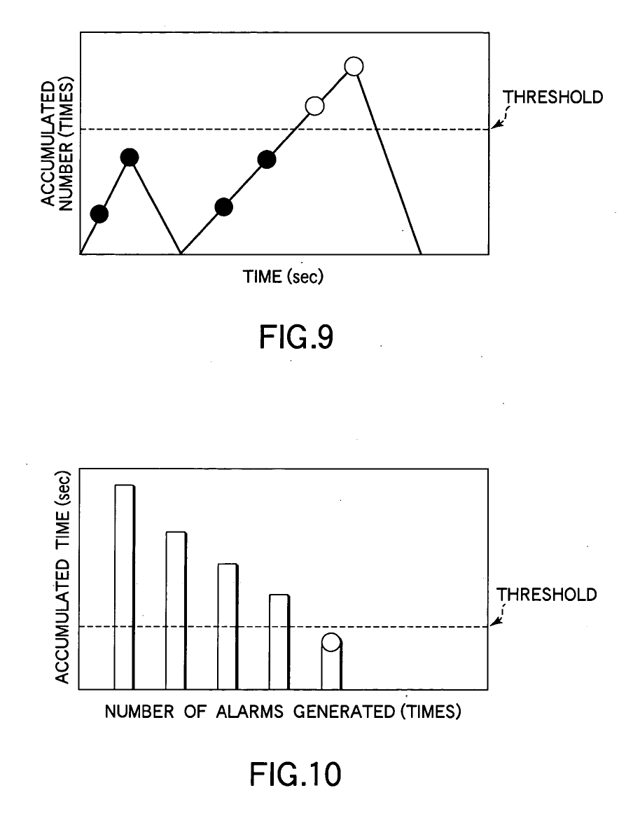

It is possible to display a graph of the circumstances of alarm generation when a detection condition is designated. FIG. 9 shows a case of displaying a graph of the number of alarm generations in a predetermined time, with the time taken on the abscissa axis and the accumulated number taken on the vertical axis, and white circle points are point where the number exceeds the threshold and warning is given. FIG. 10 shows a case of displaying a graph of the time from one alarm generation to the next alarm generation, with the number of alarm generations taken on the abscissa axis and the accumulated time taken on the vertical axis, and white circle points are point where the time exceeds the threshold and warning is given.

In addition, when the host computer 15 is downed, spooling process of process data by the AGC 17 is performed in the embodiment. That is, after recovery, the host computer 15 can immediately acquire process data over the down period from the AGC 17. Accordingly, the tracking process of each process apparatus 10 by the host computer 15 can be resumed immediately after recovery.

According to the embodiment, as described above, all or nearly all of detailed process data acquired from each process apparatus 10, typified by detection signals from the wafer inspecting device 48, the wafer detection sensor 57, the liquid-process-unit thermometer 59, the liquid-process-unit manometer 60, the liquid level sensors 82a and 82b, the thermometer and the densitometer provided in the concentration/temperature detecting section 95, etc., can be taken into the AGC 17 and intensively monitored, a change in the status of each process apparatus with time can be detected early. This can enhance the maintenance reliability of the process system including multiple process apparatuses 10. According to the embodiment, optimal process conditions can be automatically acquired from various viewpoints taking into account a change in the characteristic of each process apparatus 10 with time by updating individual pieces of data in recipes to more preferable values from results of analysis and results of statistics done on detailed process data including measured data, such as the measured result of the film thickness on the substrate, so that the reliability of the liquid process of wafers W can be improved.

By fetching process data acquired from each process apparatus 10 into the AGC 17 and performing intensive monitoring this way, the range of information that can be grasped as the statuses of the individual process apparatuses is widened so that an abnormality in apparatus, the degradation state, and the service life can be detected in greater details and earlier as compared with the case where the AGC 17 is not provided. When all processes are performed in the data analysis section 25 of the AGC 17 to grasp the status of the process apparatus as done conventionally, it is actually often difficult to sufficiently demonstrate the functions of abnormality detection and abnormality prediction due to a vast amount of data to be analyzed. According to the embodiment, however, the AGC client 17b is provided with the FDC function section 29 so that the generation state of an alarm can be analyzed, besides generation of an apparatus alarm, an abnormality in apparatus can be detected in real time, thus making it possible to detect or predict an abnormality in process apparatus and the service life thereof. Specifically, a user can set a threshold to give warning on the generation state of an apparatus alarm, such as the number of alarms generated in a predetermined time or the time from one alarm generation to the next alarm generation, and it is determined that an abnormality in apparatus has occurred when the threshold is reached, so that the status of the process apparatus can be determined surely on the user level and an abnormality in apparatus and the service life of the apparatus can be detected or predicted earlier and more reliably.

The present invention is not limited to the embodiment, but can be modified in various forms. Although the FDC function is executed when the first alarm generation is detected for predetermined detection means, for example, the FDC function may be executed from the initial state, regardless of whether or not alarm generation is detected. Although the FDC function section is provided in the AGC, it may be provided in the controller of the process apparatus. Further, the present invention should not necessarily be premised on the AGC, but the FDC function may be used alone.

Although the foregoing description of the embodiment has been given of the apparatus which rinses wafers by performing a liquid process thereon, it is not restrictive but can be adapted to other process apparatuses. An object to be processed is not limited to a wafer. It is to be noted however that in case of an apparatus which performs a sequence of processes on an object to be processed as done in the process apparatus of the embodiment, the present invention is particularly effective for there are multiple types of information to be detected and the types of alarms are vast accordingly.

Further, although the foregoing description of the embodiment has been given of the process system which has a plurality of process apparatuses, the number of process apparatuses can be one.

1. A control system comprising:
control means that controls a process apparatus, which performs a predetermined process on an object to be processed, based on information to be detected in the process apparatus; and
alarm generation means which generates an alarm when the detected information is off a predetermined range,
wherein the control means grasps a generation state of the alarm which is generated from the alarm generation means, and gives warning when the generation state reaches a predetermined threshold.

2. The control system according to claim 1, wherein the control means can set a threshold of a generation state of an alarm which is generated from the alarm generation means, grasps the generation state of the alarm, and gives warning when the generation state reaches the set threshold.

3. The control system according to claim 1, wherein the process apparatus has a plurality of detection means, and when an alarm is generated from one detection means, the control means automatically starts grasping the alarm generation state.

4. The control system according to claim 1, wherein the process apparatus has a plurality of detection means, and when an alarm is generated from a preset detection means, the control means starts grasping the alarm generation state.

5. The control system according to claim 1, wherein the alarm generation means is provided in the control means.

6. The control system according to claim 1, wherein the generation state of the alarm is a number of alarm generations within a predetermined time.

7. The control system according to claim 1, wherein the generation state of the alarm is a time from an alarm generation to a next alarm generation.

8. A control system comprising:
control means that controls a plurality of process apparatuses, which perform predetermined processes on an object to be processed, based on information to be detected in the process apparatuses; and
alarm generation means which generates an alarm when the information to be detected is off a predetermined range,
the control means including
a plurality of apparatus control units that respectively control the plurality of process apparatuses based on plural pieces of information to be detected in the individual process apparatuses,
a host computer that receives partial information from the individual process apparatuses and controls the individual process apparatuses based on that information, and
a control apparatus that receives all or nearly all information from the individual process apparatuses and controls the individual process apparatuses based on that information, the control apparatus including
means that collects information received from the individual control units and alarm information received from the alarm generation means,
means that analyzes the collected information, and
means that grasps a generation state of the alarm generated based on the alarm information, and gives warning when the generation state reaches a predetermined threshold.

9. The control system according to claim 8, wherein the means that gives warning can set a threshold of a generation state of an alarm which is generated from the alarm generation means.

10. The control system according to claim 8, wherein the control apparatus further includes means that outputs a result of the analysis and the generation state of the alarm.

11. The control system according to claim 8, wherein each of the process apparatuses has a plurality of detection means, and when an alarm is generated from one detection means, the control apparatus automatically starts grasping the alarm generation state.

12. The control system according to claim 8, wherein each of the process apparatuses has a plurality of detection means, and when an alarm is generated from a preset detection means, the control apparatus starts grasping the alarm generation state.

13. The control system according to claim 8, wherein the alarm generation means is provided in the control means.

14. The control system according to claim 8, wherein the generation state of the alarm is a number of alarm generations within a predetermined time.

15. The control system according to claim 8, wherein the generation state of the alarm is a time from an alarm generation to a next alarm generation.

16. A control method that controls a process apparatus, which performs a predetermined process on an object to be processed, based on plural pieces of information to be detected in the process apparatus, the method comprising:
grasping a generation state of an alarm, which is generated when the detected information is off a predetermined range; and
giving warning when the generation state reaches a predetermined threshold.

17. The control method according to claim 16, further comprising setting a threshold of a generation state of the alarm which is generated when detected process information is off a predetermined range, grasping the generation state of the alarm, and giving warning when the generation state reaches the set threshold.

18. The control method according to claim 16, wherein the process apparatus has a plurality of detection means, and when an alarm is generated from one detection means, grasping the alarm generation state automatically starts.

19. The control method according to claim 16, wherein the process apparatus has a plurality of detection means, and when an alarm is generated from a preset detection means, grasping the alarm generation state starts.

20. The control method according to claim 16, wherein the generation state of the alarm is a number of alarm generations within a predetermined time.

21. The control method according to claim 16, wherein the generation state of the alarm is a time from an alarm generation to a next alarm generation.

22. A process system comprising a process apparatus which performs a predetermined process on an object to be processed, and a control system which controls the process apparatus,
the control system including:
control means that controls a process apparatus, which performs a predetermined process on an object to be processed, based on information to be detected in the process apparatus; and
alarm generation means which generates an alarm when the detected information is off a predetermined range,
wherein the control means grasps a generation state of the alarm which is generated from the alarm generation means, and gives warning when the generation state reaches a predetermined threshold.

23. A process system comprising which performs a predetermined process on an object to be processed, and a control system which controls the process apparatus,
the control system including:
control means that controls a plurality of process apparatuses, which perform predetermined processes on an object to be processed, based on information to be detected in the process apparatuses; and
alarm generation means which generates an alarm when the information to be detected is off a predetermined range,
the control means including
a plurality of apparatus control units that respectively control the plurality of process apparatuses based on plural pieces of information to be detected in the individual process apparatuses,
a host computer that receives partial information from the individual process apparatuses and controls the individual process apparatuses based on that information, and
a control apparatus that receives all or nearly all information from the individual process apparatuses and controls the individual process apparatuses based on that information, the control apparatus including
means that collects information received from the individual control units and alarm information received from the alarm generation means,
means that analyzes the collected information, and
means that grasps a generation state of the alarm generated based on the alarm information, and gives warning when the generation state reaches a predetermined threshold.

24. A computer readable storage medium containing software that allows a computer to control a process apparatus, which performs a predetermined process on an object to be processed, based on plural pieces of information to be detected in the process apparatus,
wherein the software grasps a generation state of an alarm, which is generated when the detected information is off a predetermined range, and gives warning when the generation state reaches a predetermined threshold.

25. A computer program containing software that allows a computer to control a process apparatus, which performs a predetermined process on an object to be processed, based on plural pieces of information to be detected in the process apparatus,
wherein the software grasps a generation state of an alarm, which is generated when the detected information is off a predetermined range, and gives warning when the generation state reaches a predetermined threshold.
